(19) United States
(12) Patent Application Publication
(10) Pub. No.: US 2012/0272775 A1
(43) Pub. Date: Nov. 1, 2012

(54) TRANSMISSION BRAKE RELEASE TRIGGER

(76) Inventor: Byron Jesse Boyd, Hat Creek, CA (US)

(21) Appl. No.: 13/095,116

(22) Filed: Apr. 27, 2011

(51) Int. Cl. G05G 1/04; A63K 3/00

(52) U.S. Cl. 74/491; 463/58

(57) ABSTRACT

A transmission brake release trigger is used to launch a drag car off the starting line. The transmission brake release trigger may allow a user to simply pull a trigger when they see the light to go, like shooting a gun, thus eliminating the reverse muscle motion needed for conventional systems. The transmission brake release trigger may result in more consistent reaction times for drag car drivers.

### BACKGROUND OF THE INVENTION

The present invention relates to auto racing and, more particularly, to a transmission brake release trigger to launch a drag car off the starting line.

Conventional transmission brake release triggers require the user to push down a button at just the right time. It is difficult to gauge the amount of pressure exerted on the button which can give rise to a wide variance of reaction times because conventional transmission brake release triggers require the user to reverse muscle motion from pushing down to lifting up. In drag racing, race times are measured in thousandths of a second. Variable starting times can mean the difference between winning and losing a race.

As can be seen, there is a need for a transmission brake release trigger that will minimize the variability in releasing the transmission brake release.

### SUMMARY OF THE INVENTION

In one aspect of the present invention, a transmission brake release trigger comprises a handle mounted to tubing; a handle screw in the handle, the handle screw attached to a first wire of a trans brake solenoid; a linking bolt passing through the tubing, the linking bolt connecting with the handle screw when the handle is squeezed; a hammer having a hammer screw attached thereto, the hammer screw attached to a second wire of the trans brake solenoid, the hammer screw electrically connecting to the linking bolt when the hammer is depressed.

In another aspect of the present invention, a method for launching a drag car from a race start line comprises connecting a first wire of a trans brake solenoid to a handle portion of a transmission brake release trigger; connecting a second wire of the trans brake solenoid to a pivoting hammer portion of the transmission brake release trigger; engaging the hammer with a trigger; and squeezing the handle and squeezing the trigger to electrically connect the first and second wires.

These and other features, aspects and advantages of the present invention will become better understood with reference to the following drawings, description and claims.

### BRIEF DESCRIPTION OF THE DRAWINGS

FIG. 1 is a perspective view of a transmission brake release trigger with a cap removed, according to an exemplary embodiment of the present invention;

FIG. 2 is a perspective view of the transmission brake release trigger of FIG. 1, with the cap installed; and

FIG. 3 is a perspective view of the transmission brake release trigger of FIG. 1, installed in a car.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a transmission brake release trigger to launch a drag car off the starting line. The transmission brake release trigger may allow a user to simply pull a trigger when they see the light to go, like shooting a gun, thus eliminating the reverse muscle motion needed for conventional systems. The transmission brake release trigger may result in more consistent reaction times for drag car drivers.

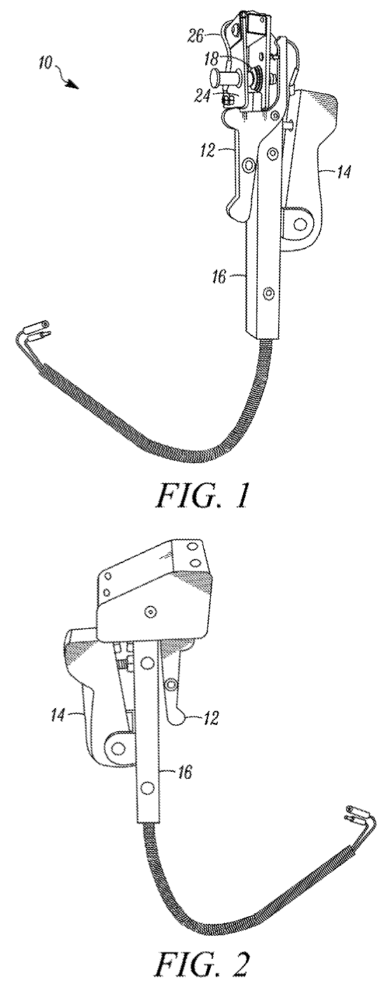

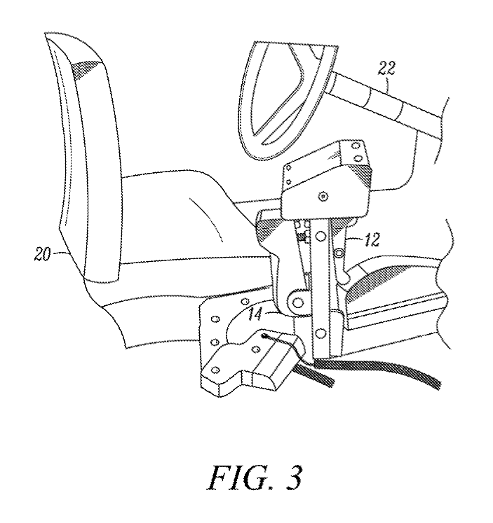

Referring to FIGS. 1 through 3, a transmission brake release trigger 10 may include a trigger 12 and a handle 14 attached to a tube 16. In some embodiments, the tube 16 may be a stainless steel square tube from about ½ to about ¾ inch square, typically about ⅝ inch square and from about 6 to about 9 inches long, typically about 7.5 inches long.

The handle 14 may be shaped like a pistol grip and may be drilled about ⅝ inch from bottom with a bolt and bushing through the handle, creating a hinge for the handle 14. The handle 14 may have an electrically conductive screw, such as a brass screw, through the top of it with a wire to the trans brake (not shown). When the user squeezes the handle 14 against a spring (the spring resiliently keeping the handle in an unsqueezed position), the handle 14 connects an open circuit that is ready to be released to make the drag car leave at the best possible time. The handle 14 may be mounted on the back of the tubing 16, near the top end thereof.

A linking screw, for example, a number 6 screw, may be mounted on the tubing 16, in line with electrically conductive screw of the handle 14. An insulated bushing may be used to electrically isolate the linking screw from the tubing 16. The screw may be the link between the handle 14 and a spring steel piece called a hammer 24. The hammer 24 may also have a screw, such as a number 6 screw, through it that is in line with the handle screw and the linking screw that goes through the tubing 16. Fastened to this hammer screw may be the other wire that goes to the trans brake solenoid. The wire may be, for example, 14 gauge wires.

In one embodiment, the hammer 24 may be about 0.042 inch thick, 1.25 inches wide, and 2 inches long, with a 1.25 inch long split in the center at the bottom of the hammer 24. This split may allow a slight amount of flex between each 0.042 inch sides which, when the device is cocked and the trigger 12 hooks the hammer 24 and maintains pressure against the brass screw, ensuring good contact until released.

The trigger 12 may be adapted to engage a lower edge of the hammer 24 when the transmission brake release trigger 10 is in a cocked position. A spring 18 may resiliently press the hammer 24 against the trigger 12. In this position, the trigger 12 may be squeezed to move the screw of the hammer 24 into the linking screw, causing electrical contact between the two trans brake solenoid wires. The trigger 12 may be about 4 inches long and about 0.25 inch wide. In some embodiments, the trigger 12 may be made of aluminum. A spring may be disposed to keep the trigger 12 in an unsqueezed position. The trigger 12 may have an adjustable stop to create the desired amount of pull before released. The trigger stop may be achieved through a number 6 button head screw in the trigger, with a conical spring wrapped therearound for adjustment.

The hammer 24 may be mounted on a 1.25 inch wide hinge and the spring 18 may be a conical spring set between the hammer 24 and a backing plate. Many of the components may be covered with a cover, such as an aluminum cover, bolted over the top to the backing plate. The handle 14 and the trigger 12 may be accessible when the cover is in place.

When the cocked trigger is pulled, the car may launch from the starting line. Because pulling a trigger, versus pushing down on a button and then lifting off that button, is so much less muscle motion, a user can cut 0.015 to 0.020 of a second off their leave time.

The transmission brake release trigger 10 may be mounted on the floor of the car, next to the car seat 20, or, in an alternate embodiment, may be mounted one the steering wheel 22. In this embodiment, the tubing 16 may be shorter, for example, about 2.5 inches in length. In some embodiments, an optional trigger with a trigger guard may be employed to keep the user from accidentally pulling the trigger. The trigger guard may provide a reference position so that a user, especially one wearing gloves, may have a good feel for the position of the trigger. In still further embodiments, an adjustable finger position attachment may be mounted to the tubing 16 on the front with a button head bolt, typically a number 6 stainless steel button head bolt. This finger position attachment may be slotted and curved in a way so the user can position a stove bolt as a finger stop to delay their reaction time if the user is struggling with a car that is extra quick off the line and a delay box is not permitted.

It should be understood, of course, that the foregoing relates to exemplary embodiments of the invention and that modifications may be made without departing from the spirit and scope of the invention as set forth in the following claims.

4

What is claimed is:

1. A transmission brake release trigger comprising:
a handle mounted to tubing;
a handle screw in the handle, the handle screw attached to a first wire of a trans brake solenoid;
a linking bolt passing through the tubing, the linking bolt connecting with the handle screw when the handle is squeezed;
a hammer having a hammer screw attached thereto, the hammer screw attached to a second wire of the trans brake solenoid, the hammer screw electrically connecting to the linking bolt when the hammer is depressed.

2. The transmission brake release trigger of claim 1, further comprising a trigger, the trigger adapted to retain the hammer in a cocked position wherein pulling the trigger causes the hammer to be depressed.

3. The transmission brake release trigger of claim 1, further comprising a spring for resiliently separating the hammer screw from the linking screw.

4. The transmission brake release trigger of claim 1, further comprising a spring for maintaining the handle in an unsqueezed position.

5. The transmission brake release trigger of claim 2, further comprising a spring for maintaining the trigger in an unsqueezed position.

6. The transmission brake release trigger of claim 2, wherein the trigger includes an indent to engage the hammer, and wherein, when the indent is not engaged with the hammer, squeezing the trigger does not depress the hammer.

7. The transmission brake release trigger of claim 1, wherein the handle is hingeably mounted on the tubing.

8. The transmission brake release trigger of claim 2, wherein the trigger is hingeably mounted on the tubing.

9. A method for launching a drag car from a race start line, the method comprising:
connecting a first wire of a trans brake solenoid to a handle portion of a transmission brake release trigger;
connecting a second wire of the trans brake solenoid to a pivoting hammer portion of the transmission brake release trigger;
engaging the hammer with a trigger; and
squeezing the handle and squeezing the trigger to electrically connect the first and second wires.

10. The method of claim 9, further comprising:
squeezing the handle to electrically connect the first wire to a first side of a linking bolt; and
squeezing the trigger to electrically connect the second wire to a second, opposite side of the linking bolt.
